(19) United States
(12) Patent Application Publication
(10) Pub. No.: US 2016/0055757 A1
(43) Pub. Date: Feb. 25, 2016

(54) APPARATUS AND METHOD FOR MEASURING METRICS FOR EXTRACURRICULAR ACTIVITIES

(71) Applicant: Necessity LLC, Westlake Village, CA (US)

(72) Inventors: Srinivas Santhanam, Simi Valley, CA (US); Srividya Srinivas, Simi Valley, CA (US)

(21) Appl. No.: 14/832,917

(22) Filed: Aug. 21, 2015

Related U.S. Application Data
(60) Provisional application No. 62/040,920, filed on Aug. 22, 2014.

(51) Int. Cl. G09B 7/02; G09B 5/06

(52) U.S. Cl. CPC G09B 7/02; G09B 5/06; G06Q 50/205

(57) ABSTRACT

There is disclosed an apparatus comprising for measuring metrics for extracurricular activities comprising: a nontransitory storage medium storing a server system program having instructions which when executed by one or more processors will cause the processors to operate a computerized server system, the instructions of the server system program for managing availability of reservations of resources, receiving a request from a consumer to securely login to the system, the consumer viewing the details input by a provider for a training session, the consumer viewing the metrics for a child's participation in extracurricular activities.

### RELATED APPLICATION INFORMATION

This patent claims priority from the following provisional patent applications: U.S. Application No. 62/040,920 entitled, “Apparatus and Method for Measuring Metrics for Extracurricular Activities” filed Aug. 22, 2014.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to a secure system to manage extracurricular activities for kids.

2. Description of the Related Art

Parents invest billions of dollars on their children's multiple extracurricular activities, from their pre-kindergarten years through college, roughly from the age of 5 to the age of 18. However, there is no solution for measuring the amount parents spend on an extracurricular activity over the course of the child's lifetime. In addition, there is no solution to measuring a child's on-going improvements. Similarly, there is no solution for allowing parents to participate actively in their child's progress in the extracurricular activity. The problem is so systemic that most parents are not aware that the problem exists until their kids are almost into their late teens when it may be too late to remedy the situation.

Many talented local or global community organizations have volunteers or staff members who may have the time to coach, volunteer or mentor a child in an extracurricular activity. However, there aren't any systems that make it convenient to leverage these volunteers or staff members who may have the ability to help a child in an extracurricular activity.

As such, there is a need for a system that parents can utilize that will help measure a child's extracurricular activities and a child's performance within an activity.

### DESCRIPTION OF THE DRAWINGS

FIG. 1 is a block diagram of an environment for using a system to measure metrics for extracurricular activities.

FIG. 2 is a block diagram of a computing device.

FIG. 3 is a block diagram of an apparatus for measuring metrics.

FIG. 4 is a flowchart of a method for using a system to measure metrics for extracurricular activities.

FIG. 5 is an example of a process for determining an overall profile score for a student.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

The apparatus described herein provides a secure mechanism of capturing ongoing metrics of school age children in grades pre-kindergarten through twelfth grade. School age children are involved in a variety of activities including sports, music, arts, volunteering, special services and language.

The apparatus described herein captures and delivers quantitative and qualitative metrics for a student's overall performance in an extracurricular activity. The apparatus also delivers active monitoring and measurement of a student's progress so a student can evaluate his progress and understand how to strengthen his skills. In addition, the apparatus provides a feedback mechanism whereby a mentor can provide objective feedback to a student to help identify SWOTs (Strengths, Weaknesses, Opportunities and Threats). The feedback mechanism can help a parent determine early on if a student requires, or would benefit from, additional assistance in a certain area. Early intervention may help to save time for parents, as well as use their effort and money in a beneficial manner, while also ensuring their participative decision making. It essentially applies the principles of management by objectives & SMART goals to an individual's extracurricular lifecycle thereby helping him or her to “Be Better” in what they do and improve their overall well-being en-route to their college aspirations.

The apparatus additionally provides the mentors of the extracurricular activities an online platform or marketplace to connect and provide their teaching services locally or globally and/or pursue their passion in their own convenient spare times without worrying about the technological obstacles in trying to search, locate and market a mentor's services to a group of customers.

The apparatus provides for capturing, tracking and objective feedback mechanism (including audio/voice, video, analytics etc.) on measurements and metrics for long-term fine tuning and improvements unlike any other systems in this field which primarily just match resources for short-term needs. It helps enhance the students' lifelong learning process while providing them with tangible and intangible benefits.

Other systems do not focus on long-term metrics or non-professionals (including amateurs etc.) but instead on short-term match-making or for professionals only or on one activity only. As a result there is limited scope for ongoing improvements or tuning on multiple activities or holistically looking at everything that an individual does or doesn't for personalized improvisations, etc.

The apparatus provides for long-term metrics, helps fine tune for multiple extracurricular activities, helps parents to focus kids on specific activities (including sports, music, language, volunteering, special services etc.) in which they have natural extra edge in or better scores and ranking in.

The apparatus focuses on a basket of extracurricular activities extending beyond school education for one individual, overall for his/her well-rounded lifecycle development—providing a single comprehensive dashboard for an individual's lifetime of multiple extracurricular achievements over a spectrum of time, location, age etc.

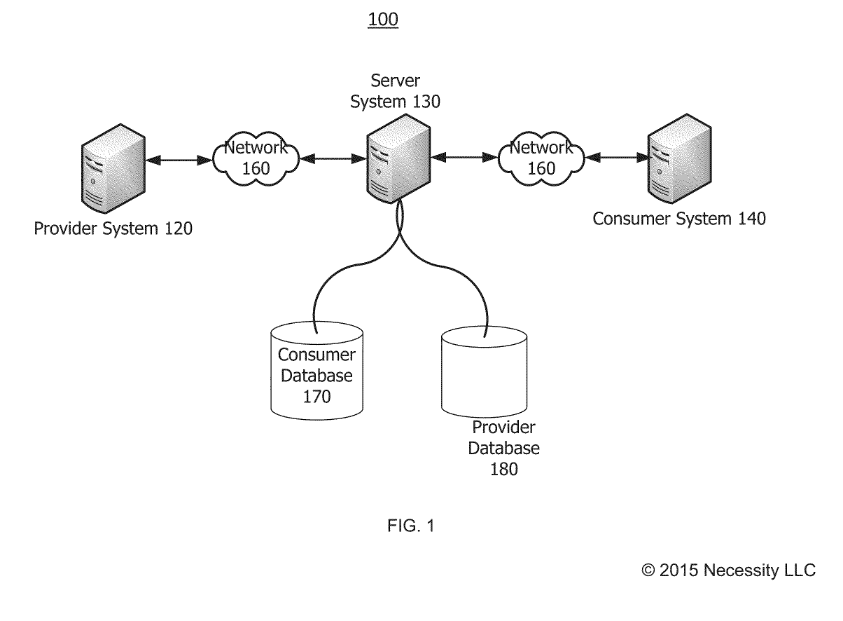

Referring now to FIG. 1, there is shown a block diagram of an environment 100 for measuring a student's performance and his metrics related to his extracurricular activities. The environment 100 includes a provider system 120, a server system 130, a consumer system 140, a provider database 180 and a network 160 for interconnecting computer systems 120, 130, 140. The server system 130 may have access to a consumer database 170 and a provider database 180. The server system 130 may be operated by an operator and may be integrated with other IT systems of the operator. As used herein, the term “provider” is used to describe a mentor, teacher, or other professional who is providing services to others in the system. As used herein, the term “consumer” is used to describe a parent, or a student, who is using the system to discover providers for different activities.

Various people may operate aspects of the environment 100, including a provider of the provider system 120 and a consumer of the consumer system 140. Each of these users may have secure access and control over their respective systems. Furthermore, users may obtain the functionality hereof through non-specified devices having the capability of performing the functionality described herein.

The server system 130 may be a computing device having server software such as web server software. The partitioning of the databases 170 and 180 into the two functional units as shown is for ease of discussion and does not imply a corresponding physical division or structure. The databases 170 and 180 may be distributed. Metadata arising from transactions may be stored in the databases 170, 180.

The provider system 120 and the consumer system 140, which are representative of a number of customer systems, may be computing devices and may include web browser software which allow them to browse the server system 130 and engage in transactions with the server system 130.

The network 160 is a data network, and may be or include the Internet. The network 160 and the systems communicating through the network 160 may support secure communications.

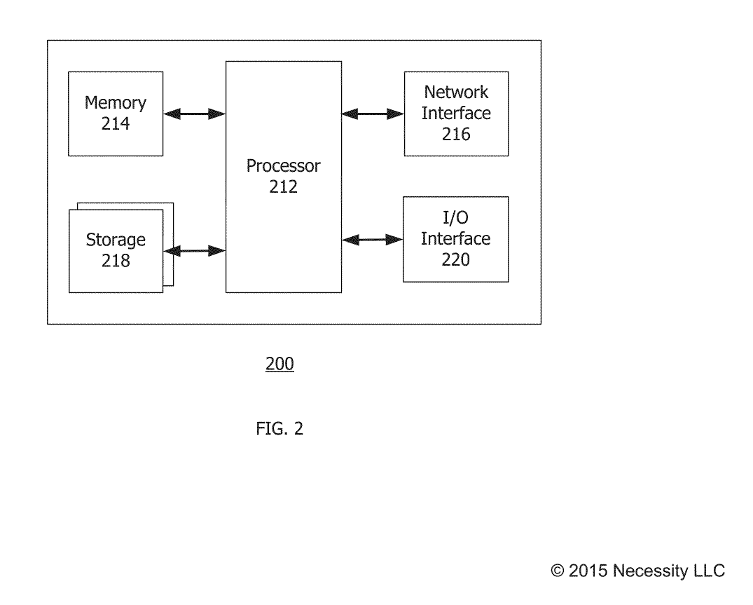

Turning now to FIG. 2 there is shown a block diagram of a computing device 200, which is representative of the server system 130, the provider system 120, and the consumer system 140 in FIG. 1. The computing device 200 may be, for example, a desktop or laptop computer, a server computer, a tablet, an iPad or other mobile or smart device. The computing device 200 may include software and/or hardware for providing functionality and features described herein. The computing device 200 may therefore include one or more of: logic arrays, memories, analog circuits, digital circuits, software, firmware and processors. The hardware and firmware components of the computing device 200 may include various specialized units, circuits, software and interfaces for providing the functionality and features described herein.

The computing device 200 has a processor 212 coupled to a memory 214, storage 218, a network interface 216 and an I/O interface 220. The processor 212 may be or include one or more microprocessors, field programmable gate arrays (FPGAs), application specific integrated circuits (ASICs), programmable logic devices (PLDs) and programmable logic arrays (PLAs).

The memory 214 may be or include RAM, ROM, DRAM, SRAM and MRAM, and may include firmware, such as static data or fixed instructions, BIOS, system functions, configuration data, and other routines used during the operation of the computing device 200 and processor 212. The memory 214 also provides a storage area for data and instructions associated with applications and data handled by the processor 212.

The storage 218 provides non-volatile, bulk or long term storage of data or instructions in the computing device 200. The storage 218 may take the form of a magnetic or solid state disk, tape, CD, DVD, or other reasonably high capacity addressable or serial storage medium. Multiple storage devices may be provided or available to the computing device 200. Some of these storage devices may be external to the computing device 200, such as network storage or cloud-based storage. As used herein, the term storage medium corresponds to the storage 218 and does not include transitory media such as signals or waveforms. In some cases, such as those involving solid state memory devices, the memory 214 and storage 218 may be a single device.

The network interface 216 includes an interface to a network such as the network 160 (FIG. 1). The network interface 216 may be wired or wireless.

The I/O interface 220 interfaces the processor 212 to peripherals (not shown) such as displays, keyboards and USB devices.

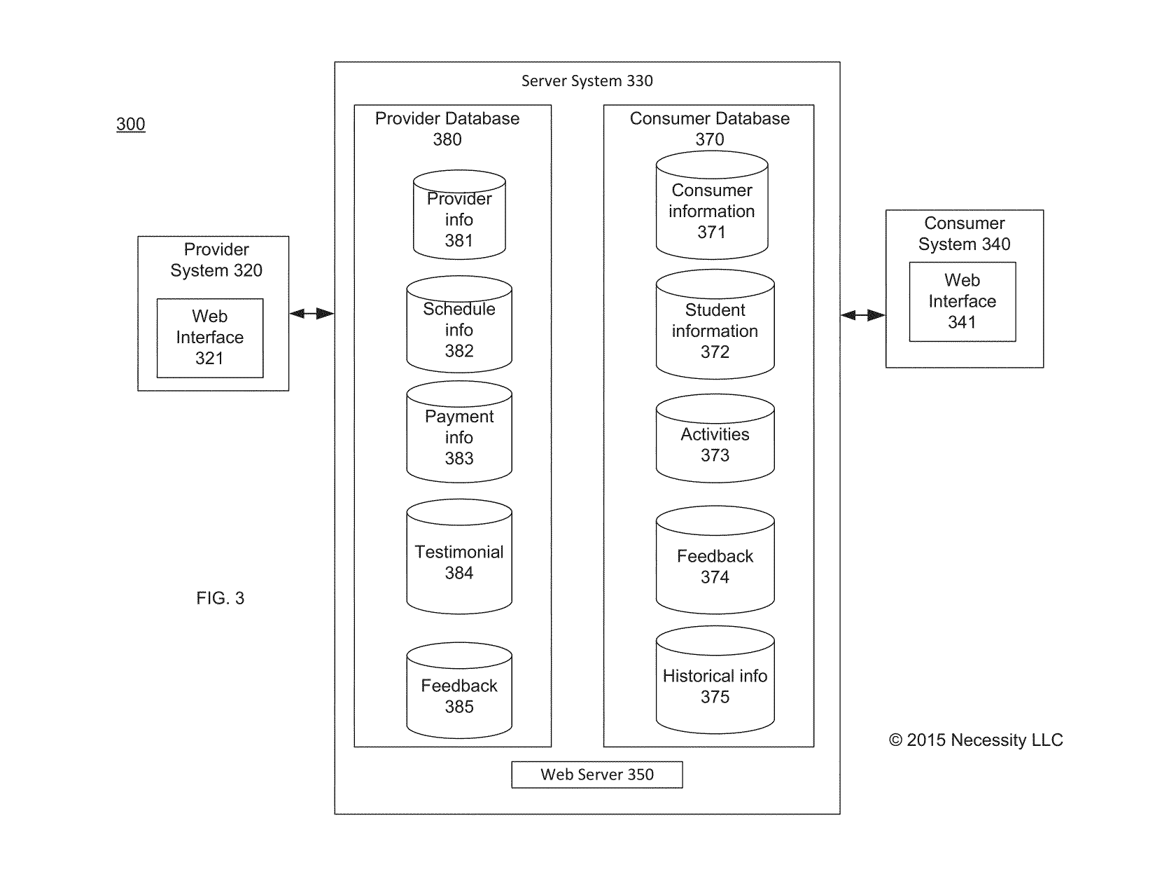

Referring now to FIG. 3, there is shown a block diagram of an apparatus for measuring metrics. FIG. 3 comprises a server system 330, which may be server system 130 of FIG. 1, provider system 320, which may be provider system 120 of FIG. 1, and consumer system 340, which may be consumer system 140 of FIG. 1. In addition, server system 330, also comprises consumer database 370, which may be consumer database 170 of FIG. 1, and provider database 380, which may be provider database 180 of FIG. 1.

The provider system 320 and consumer system 340 include web interface 321 and 341, respectively, to allow the systems to access the server system 330.

The server system 330 comprises a web server 350 and a provider database 380 and a consumer database 370.

The provider database 380 may comprise multiple databases or may comprise only one database. As shown, it may comprise a provider information database 381, a schedule information database 382, a payment information database 383, a testimonials database 384, and a feedback database 385. The provider information database 381 may comprise information regarding the provider, such as what types of things the provider teaches, what the provider's experience is, and where the provider's centers are located. The provider database 380 also may include a scheduling database 382, which helps a provider schedule his student's lessons. The database will store the provider's scheduled activities, thereby allowing new students to find open time slots for scheduling new sessions with a provider. The payment information database 383 may offer the provider information as to whether the provider's students have paid for the lessons that he registered for. In addition, the provider database 380 may include a testimonials database 384 which stores testimonials that a student may have written about a provider. Finally, the provider database 380 may include a feedback database 385, which may store feedback that a student, or the student's parent, gives to a teacher. The system may store the feedback received from a provider's students, or the provider's students' parent, in the feedback database 385.

The consumer database 370 may comprise multiple databases or may comprise only one database. As shown, it may comprise a consumer information database 371, a student information database 372, an activities information database 373, a feedback database 374, and a historical information database 375. The consumer information database may comprise information regarding the consumer, such as where he lives, and how old his children are, and what activities the children might be interested in. The consumer database may also comprise a student information database 372. This database may have an entry for every student and may include their age, and the school they attend. In addition, it may include the student's interests. The consumer database 370 may also include an activities database 373, in which it may be stored the student's activities that he is currently enrolled in, and how many times a week he attends each activity, and how long he's been involved with the activity. In addition, the consumer database may include a feedback database 374 which may store any feedback a student receives from a provider. Alternatively, it may store feedback from a student's parent as to areas that a parent might notice might need some extra assistance from the provider. Finally, the consumer database 370 may also include a historical information database 375. This database may store information about activities that a student may have been previously enrolled in and no longer is enrolled in. For any such activities, the historical information database may store information relating to how long a student participated in other activities, as all of that information is important to how experienced their skills are.

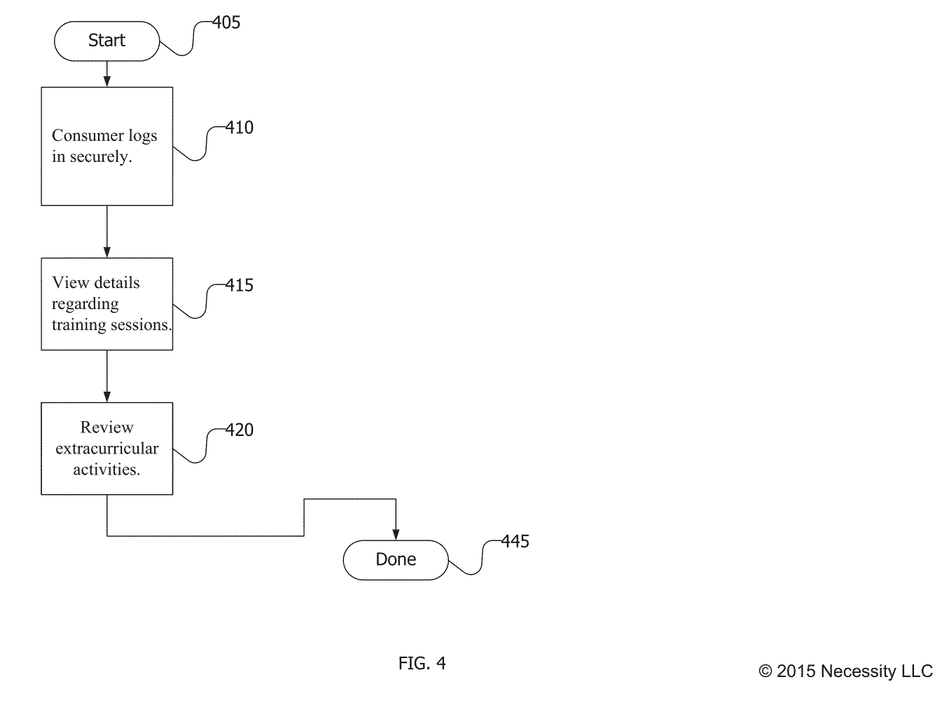

Referring now to FIG. 4, there is shown a flowchart of a method of establishing metrics for extracurricular activities. The method may use the environment 100 of FIG. 1, and in particular the server system 130. The flow chart has both a start 405 and end 445, but the process is cyclical in nature.

A consumer interested in measuring metrics for extracurricular activities, uses a consumer system, such as consumer system 140 of FIG. 1, to securely log into the system, such as server system 130 of FIG. 1, at 310, or opens up the app for the system on his smart device. Once logged in, the consumer may identify and select the child that the consumer wants to review the data for. Providers can subscribe and advertise their skills on the platform (for local or global needs). Parents (for their kids) or other adults can search for providers of varied skills and costs and locations and upon finding a fit, connect with the providers to avail of their services, exchanging contact info, scheduling services, validating or verifying using social media presence, making calendar appointments, etc.

Once the Providers access the Application/Software securely including via the Web on their computers or as Web App or Mobile Client Apps, (via mobile devices) by logging in using their secure user id's and passwords, they will input and record in real-time (fresh and accurate) the objective feedback of their Consumers' (kids or adults) training sessions for a given day and time. These could include a summary in text, voice/audio, video, the hours and time of play, play-by-play objective feedback for a particular activity, and details of a given training session.

Once the Consumers (Parents if usage is for kids else Adults) access the Application/Software via the Web on their computers or as Web App or Mobile Client Apps (via mobile devices), by logging in using their secure user id's and passwords, they can view the recorded details including the objective feedback, at 415, of their Providers training sessions for their kids on a given day and time. These could be a summary in text, voice/audio, video, the hours and time of play, play-by-play objective feedback for a particular activity, and details of a given training session.

This information will help plot the growth and increasing expertise of an individual over a period of time in a particular extracurricular activity or event. It will also provide the money spent on a particular activity so that budget conscious parents can make better choices of where to put in the money for their kids enjoyment and improvement in a particular extracurricular activity, enabling for their participative decision making process.

The providers will input their measurements based on their monitoring of their consumers' extracurricular activities into the software (accessible on mobile App's, Web browser UI, etc.), via their mobile phones (cell or smartphone), tablets or computers. This information will be stored securely for each consumer under that particular provider as record or data information in the system.

Based on a continuing evaluation of the objective feedbacks and data assimilated, the consumers (parents) can make choices of continuing the program, resetting their expectations, providing for increased coaching or training, etc. via ongoing analytics features. From a consumer perspective, this secure Dashboard will be for any/all activities with one or multiple providers, for one or multiple activities, all based on individual student or kid records. It will also be available for multiple parents via their separate id's to handle for all kinds of households. It will also cater to the management of multi-kids families as well as multi-parents managing one or more kids all facilitated via streamlined processes.

At 420, consumers can securely see all their records for all sports, music, language etc. in one Dashboard view. Providers can securely see all the records for only the activities they provide and their specific customers. An example could be of a kid who plays tennis, soccer, basketball, and is musically inclined playing piano, violin and also volunteers helping homeless or under-served communities etc. This Dashboard will enable bringing all these together for the parents to make better decisions for their kids on the path to college as individual coaches or trainers may not be able to weigh the impact of the various extracurricular activities (leads to TurtleMap™).

The system is capable of showing the actual dedicated hours spent right from the initial life stages. Specifically, for kids, providing assimilated information as an overall package. The assimilated information may be presented in a manner similar to a GPA, namely it may serve as a differentiator and true assessment of overall well-rounded personality with future information based on constant “pivoting” with coaches, colleges, schools and parents. It provides for bi-directional, digital interactions including Consumer to Provider and Provider to Consumer.

It will also help parents reflect on the money spent and ensure its channeled on the appropriate activity to strengthen and participate in the decision making to embolden their kids future college education prospects.

It helps coaches, trainers or mentors (professionals for full-time efforts as well as talented resources with spare capacity for part-time efforts, including, high school and college graduates, unemployed, veterans, seniors, retirees, and a peer-to-peer model) to focus on kids while the marketplace platform facilitates other technological aspects of search, connect, payment, advertising for small business owners or self-employed entrepreneurs in extracurricular activities.

Providers capture pertinent skill-set information about their Consumers involved in various extracurricular activities (including sports, music, language, volunteering, special aid, etc.) on mobile devices or laptop/desktop computers using either, audio/voice, video or text on a regular basis during or immediately after providing the service. Using this information, the providers can view each individual consumer's lifecycle of progress over a period of time, on the desired extracurricular activity, in a manner that adds value for the consumer or their parents who pay for said services enabling a much better participative decision making process for their kids. The providers can share the same information during one on one sessions with the consumers (kids & parents or adults) and the consumers as well can get access to all their progress and pertinent information.

Decisions based on analytics can then be made of a consumer's (kids & parents or adults) effectiveness on a particular activity, the continuance of time the kids (or individual's) spent on that particular activity, the charting of progress to be captured for college admissions, to portray the overall well-rounded development, persistency and accolades (if/when acquired) of the Consumer (a XPA/I™ (for extracurricular) beyond the school education GPA). But, in a consistent manner of achievements during the lifecycle from pre-kindergarten through school senior years (ages 5-18+) etc. This information can be made available as packages to the consumers if/when needed. Which could be used for “memorable” recaptures or reconnect collages, college admissions, proof of expertise or persistency over the years, leading to scholarships or grants etc.

It provides for summarized extracurricular LifeCycle metrics, as effort-tracker packages (at an individual level in multiple extracurricular activities on an ongoing, annual or at graduation times) that would be useful for college applications and scholarships (a XPA/I™ (for extracurricular Personal Achievement/Index) similar to education GPA's) or for their job profiles, which are not provided by any other invention today.

The XPA/I™ (or potentially a NESS score™) will provide for personalized insights into results and achievements and not necessarily compare an individual's standing versus the world, as every individual is different and unique, unlike GPA's.

Achievements and awards in extracurricular activities are among the most important factors for college admissions after GPA's & SAT scores. These show the kid's accomplishments, community involvement and leadership skills, as well as passion and persistency in achieving their extracurricular goals. This invention, essentially, is the first platform to focus on this need to cater to parents and kids and their aspirations of getting an excellent education in great colleges on the basis of overall skills, traits and quality of an individual assimilated slowly and steadily from pre-kindergarten through college, a key and unique differentiator (Slow and Steady Wins the Chase™).

These features for end-state vision of assimilating data and using it, show persistency, motivation, versatility, aptitude, attitude and other key development aspects needed for consideration during college admissions This system captures data over the lifetime of the individual. Offering authenticity to not having been done in a binge setting just before college applications.

The vision is to focus on the individual (“Everyone's Got Talent”™; “Everyone is Special”™; “Individual Talent Chart”™, e.g. visual representation of sports up/down, music up/down, student view: plot achievements over time, parent view: plot spend over time, providers view: help tune talent better and not lose track of individual achievements amongst the crowd of participants and provide authenticity of credentials in extracurricular activity, etc.).

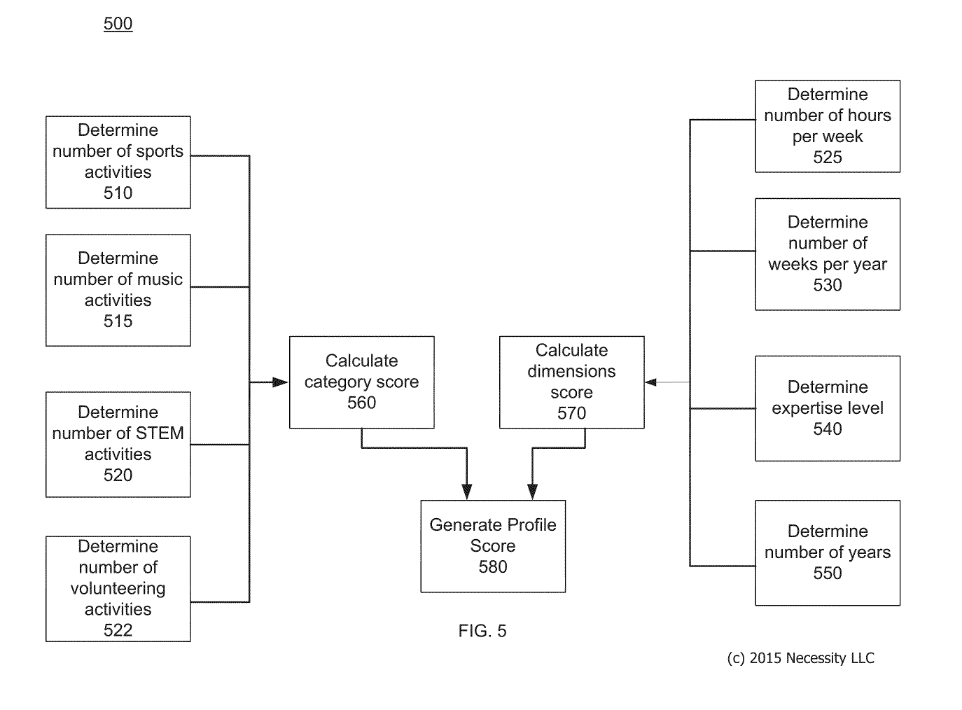

Referring now to FIG. 5, there is shown an example of a process for determining an overall profile score for a student. The overall profile score combines a quantitative and qualitative measurement of a student's overall ability. The overall profile score can be used to determine a student's strength in extracurricular activities. Colleges and future employers can use the overall profile score to evaluate a student's commitment and skillset learned from his extracurricular activities over the years. A higher score indicates that the student excelled likely at numerous activities and has developed significant expertise. The profile score can even help future employers evaluate a student, or future employee's, ability to grasp new skills, and also a student's commitment level. The profile score typically comprises a category score, and a dimensions score. The process described below for determining an profile score is described by first determining a category score, and then determining a dimensions score.

The process for determining a student's overall profile score begins with step 510 during which the server system, such as server system 130 of FIG. 1, determines the number of sports in which a student has participated. The server system will likely perform a query on the consumer database, such as consumer database 180 of FIG. 1. The server system will issue a query on the consumer database to determine for a particular student, how many sports activities in which he has participated. For example, a student may have participated in football and soccer. The system may store this information in an activities database, such as activities database 373 of FIG. 3. If a student has not participated in any sports activities, then the system will generate the number 0 when queried for how many sports in which the student was involved.

After the number of sports activities is determined, the process proceeds to 515 to determine the number of music activities in which a student has participated. Similar to step 510, the server system will likely perform a query on the consumer database. The server system will issue a query on the consumer database to determine for a particular student, how many music activities in which he has participated. For example, a student may have participated in vocal lessons, guitar and piano. The system may store this information in an activities database, such as activities database 373 of FIG. 3. If a student has not participated in any music activities, then the system will generate the number 0 when queried for how many music activities in which the student was involved.

After the number of sports activities is determined, the process proceeds to 520 to determine the number of STEM (Science, Technology, Engineering and Mathematics) activities in which a student has participated. Similar to step 510, the server system will likely perform a query on the consumer database. The server system will issue a query on the consumer database to determine for a particular student, how many STEM activities in which he has participated. For example, a student may have participated in a life sciences activity as well as a mechanical engineering activity. The system may store this information in an activities database, such as activities database 373 of FIG. 3. If a student has not participated in any STEM activities, then the system will generate the number 0 when queried for how many STEM activities in which the student was involved.

After the number of sports activities is determined, the process proceeds to 522 to determine the number of volunteering activities in which a student has participated. Similar to step 510, the server system will likely perform a query on the consumer database. The server system will issue a query on the consumer database to determine for a particular student, how many volunteering activities in which he has participated. For example, a student may have participated in an organization that held community service activities, as well as a student may have been involved with a non-profit charitable organization. Alternatively, a student may have volunteered time at a medical facility, or other organization. The system may store this information in an activities database, such as activities database 373 of FIG. 3. If a student has not participated in any volunteering activities, then the system will generate the number 0 when queried for how many volunteering activities in which the student was involved.

After the system determines the number of activities in which a student has participated, the process then proceeds to 560 to calculate a category score. The category score can be calculated by adding all of the numbers generated for each of the activities from steps 510, 515, 520 and 522. For example, if a student participates in tennis, piano, science and math, the student would have a category score of 4, which would result from adding a score of 1 from step 510, a score of 1 from step 515 and a score of 2 from step 520.

After a category score is determined at 560, a dimensions score is determined. At step 525, it is first determined how many hours per week in which a student has participated in all of his activities. For example, if a student spends three hours per week on extracurricular activities, then the dimensions score would equal 3. The server system will likely determine the hours spent on activities by issuing a query on the consumer database to determine for a particular student, how many hours per week a student has spent on his activities.

After the number of hours is determined at 525, the process proceeds to 530 to determine the number of weeks per year a student spends on the activities. Similar to step 525, the server system will likely perform a query on the consumer database. The server system will issue a query on the consumer database to determine for a particular student, in which how many weeks in a year the student has participated. For example, a student may have participated on extracurricular activities for 12 weeks in a year. Alternatively, a student may spend all 52 weeks involved in extracurricular activities. The system may store this information in an activities database, such as activities database 373 of FIG. 3.

After the number of weeks is determined at 530, the process proceeds to 540 to determine a student's expertise level. Similar to step 525, the server system will likely perform a query on the consumer database. The server system will issue a query on the consumer database to determine for a particular student, how his providers have rated his expertise. A student's provider may input a score into the system that determines a student's expertise in a certain activity. Alternatively, the system could automatically generate an expertise level score based on the overall feedback that a student received from his providers. For example, a student who has participated in piano lessons for 3 years, may be rated at an expertise level for 4 indicating that the student is quite advanced in his piano skills Alternatively, a student who has participated in piano lessons for 6 years, may be rated at an expertise level of 5 signifying that he has developed very advanced piano skills A higher score signifies more expertise.

After the expertise level is determined, the system determines the number of years at 550 that a student has participated in extracurricular activities. For example, if a student is 12 years old and has participated in extracurricular activities since the age of 6, then the system would identify 6 as the number of years for that student. The server system will likely issue a query on the consumer database to determine for a particular student, the number of years that a student has participated in activities. If a student has been participating in activities for some time before a parent signs up with the system, then the parent can identify how many years the student has been involved with various activities when the parent registers an account with the system. Alternatively, if a student has not been enrolled in any extracurricular activities at the time the parent registers with the system, then the parent can identify such so the system can accurately identify how long a student has been involved with different activities.

Following step 550, the dimensions score is calculated at 570. The dimensions score can be determined in many ways. One way the dimensions score can be calculated is by multiplying the student's expertise level with the number of years that a student has been participating in extracurricular activities. For example, if a student's expertise level is rated at 3, and a student has been participating in extracurricular activities for 5 years, then the student would have a dimensions score of 15. Alternatively, a student who had an expertise level of 5 and had been participating in extracurricular activities for 6 years, would have a dimensions score of 30. As with the category scores, a higher score identifies that the student likely is more experienced and more refined with his extracurricular activities. While this example uses absolute values, the dimensions score likely will be a weighted value since a person who may have an expertise level of 5 but has been learning for 1 years will have a dimensions score of 5, which is not the same as someone with an expertise level of 1 but has been learning for 5 years. Therefore, the system may add a weighted component to the dimensions score to accurately reflect these differences.

After the dimensions score is calculated at 570, then a profile score is generated for a student at 580. The profile score may be calculated by multiplying the category score and the dimensions score. For example, if a student has a category score of 4, meaning he has participated in 4 different extracurricular activities, and that student has a dimensions score of 15, calculated by multiplying the expertise level and the number of years a student has participated in extracurricular activities, then the student's profile score likely would be 60, which is calculated by multiplying a category score of 4 with a dimensions score of 15. As with the category score and the dimensions score, a higher profile score indicates that a student has developed a strong skillset in a few or many extracurricular activities. While this example uses absolute values, the profile score likely will be a weighted value so that a person's category score and dimensions score adequately represent an individuals' skillset.

In addition to generating a profile score, the system can also provide feedback messages to a student. For example, a provider can offer feedback to a student using a chat module on a dashboard in the system. In addition, a student can comment on the feedback from the provider. This mechanism can allow for continuous feedback to a student thereby helping the student to focus and develop his skills in a thoughtful manner. This feature is also beneficial as it provides a provider with a direct channel to communicate with a student thereby helping to improve the student's skills.

Another aspect of the system is the system can generate certificates for a student. These certificates can provide cumulative feedback to a prospective employer, and can also be used as part of a college application to show the breadth and depth of a student's activities. These certificates can be generated from the system and will include a seal of authentication based on the student's actual participation over a period of months or years in any given activity. These certificates will be stored in the system, and will continue to increase for a student over his lifecycle.

Another aspect of the system is the system can provide information and incentives for scholarships. The scholarship feature is a local community based distribution approach to help students and providers in each specific city with need-based scholarships or school/classroom supplies scholarships improving higher education/career prospects. It helps focus the scholarship on those with real needs while also giving back to the community. The system will deliver this feature through a revenue generation model. That is, each representative city gets a certain percentage of the money given back to the community. If a certain city generates a certain amount of money, then a certain percentage of that money may go back to that city specifically.

In addition, the system can assist consumers with determining carpool options and jobs. For example, if a consumer has a student enrolled with a certain provider, the provider may be able to suggest via the feedback mechanism, a person that lives close the consumer and visits the same provider. Alternatively, the system may generate recommendations of nearby consumers that visit the same provider, so that the consumers can discuss if they need to carpool together. Similarly, providers and/or consumers of the system may be able to input information relating to jobs in the area in which they live. This jobs information may be readily available to all providers and/or consumers that live within a certain geographic area. Alternatively, the person listing the jobs information may select who is permitted to receive the information regarding jobs might be available.

The system described herein is a social networking and relationship platform helping make long term connections through a lifetime of residency with local community and neighborhoods.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. An apparatus for measuring metrics for extracurricular activities comprising:
a nontransitory storage medium storing a server system program having instructions which when executed by one or more processors will cause the processors to operate a computerized server system, the instructions of the server system program for managing availability of reservations of resources:
receiving a request from a consumer to securely login to the system;
the consumer entering input into the system relating to a student for which the consumer is looking for a provider for the student;
the consumer viewing the details input by the provider for a training session;
the consumer viewing testimonials from the provider; and
the consumer requesting additional information regarding registering the student for a class with the provider.

2. The apparatus of claim 1 wherein:
the metrics for a child's participation is determined by:
determining a category score,
determining a dimensions score,
and determining a profile score, whereby the profile score is generated by multiplying the category score and the dimensions score.

3. The apparatus of claim 1 wherein the consumer requests a feedback information from the provider regarding the student's development.

4. The apparatus of claim 3 wherein the consumer provides a second feedback information to the provider.

5. The apparatus of claim 2 wherein the category score is determined by
generating the number of sports activities the student is involved in;
generating the number of music activities the student is involved in;
generating the number of STEM activities the student is involved in;
generating the number of volunteering activities the student is involved in;
adding the generated numbers to create the category score, and
storing the category score in the system for the student's profile information.

6. The apparatus of claim 5 wherein the dimensions score is determined by
generating an expertise level for the student, and
generating a number of months in which the student has participated in an activity; and
multiplying the expertise level and the number of months to generate a dimensions score; and
storing the dimensions score in the system.

7. The apparatus of claim 6 wherein the expertise level for the student is generated by the provider.

8. A method for measuring metrics for extracurricular activities comprising:
receiving a request from a consumer to securely login to the system;
the consumer entering input into the system relating to a student for which the consumer is looking for a provider for the student;
the consumer viewing the details input by the provider for a training session;
the consumer viewing testimonials from the provider; and
the consumer requesting additional information regarding registering the student for a class with the provider.

9. The method of claim 8 further comprising
determining a student's performance by determining a category score,
determining a dimensions score,
and determining a profile score, whereby the profile score is generated by multiplying the category score and the dimensions score.

10. The method of claim 8 wherein the consumer requests a feedback information from the provider regarding the student's development.

11. The method of claim 10 wherein the consumer provides a second feedback information to the provider.

12. The method of claim 9 wherein the category score is determined by
generating the number of sports activities the student is involved in;
generating the number of music activities the student is involved in;
generating the number of STEM activities the student is involved in;
generating the number of volunteering activities the student is involved in;
adding the generated numbers to create the category score, and
storing the category score in the system for the student's profile information.

13. The method of claim 12 wherein the dimensions score is determined by
generating an expertise level for the student, and
generating a number of months in which the student has participated in an activity; and
multiplying the expertise level and the number of months to generate a dimensions score; and
storing the dimensions score in the system.

14. The method of claim 13 wherein the expertise level for the student is generated by the provider.
